(19) United States
(12) Patent Application Publication
(10) Pub. No.: US 2004/0252383 A1
(43) Pub. Date: Dec. 16, 2004

(54) Lens barrel

(75) Inventor: Atsushi Hamada, Saitama (JP)

Correspondence Address: FOLEY AND LARDNER, SUITE 500, 3000 K STREET NW, WASHINGTON, DC, 20007, US

(73) Assignee: TAMRON CO., LTD.

(21) Appl. No.: 10/751,882

(22) Filed: Jan. 7, 2004

(30) Foreign Application Priority Data
Jan. 7, 2003 (JP) 2003-001606

(51) Int. Cl. G02B 15/14

(52) U.S. Cl. 359/704

(57) ABSTRACT

A lens barrel includes a lens that has a plurality of sliding surfaces on an outer peripheral edge of the lens; and a lens frame that has a plurality of lens-receiving sections on an inner peripheral edge of the lens frame and accommodates the lens. The sliding surfaces have different heights in a direction perpendicular to an optical axis of incident light. Each of the lens-receiving sections comes in contact with one of the sliding surfaces.

### BACKGROUND OF THE INVENTION

1) Field of the Invention

The present invention relates to a lens barrel capable of moving and adjusting, in an optical axis, a lens frame of a lens that is an image enlarging unit used for a projector, a moving-picture machine and the like.

2) Description of the Related Art

FIG. 14 is a sectional view illustrating a partial configuration of a conventional image enlarging lens barrel used for the projector, the moving-picture machine and the like. The image enlarging lens comprises a plurality of lenses in many cases. FIG. 14 shows a first group of the image enlarging lens.

This first lens group includes a first lens 1, a second lens 2 and a third lens 3 which are disposed in this order from the side closer to an image (not shown). These lenses are held by a lens frame 4. In order to form an image (size, focus, and the like) which is most suitable for a screen size to be projected, a washer 6 having a predetermined thickness is inserted between the second lens 2 and a second lens-holding section 5 of a lens frame 4 which holds the second lens 2, and distances between the second lens 2, the first lens 1 and the third lens 3 are adjusted. Such a conventional image enlarging lens barrel is disclosed in, for example, Japanese Utility Model No. H7-36332 and Japanese Patent Application Laid-open No. H8-136792.

An adhesive is used for fixing the second lens 2 to the second lens-holding section 5 shown in FIG. 14. When the washer 6 (see FIG. 11) is inserted to adjust the distance between the second lens 2 and the second lens-holding section 5, the adhesive is used at two locations, i.e., a location between the second lens 2 and the washer 6 and a location between the second lens-holding section 5 and the washer 6. When a plurality of washers 6 are to be used, it is also necessary to adhere the washers 6 to each other. In the conventional technique as described above, a position of the second lens 2 is adjusted utilizing the thickness of the washers 6 which are laminated in the direction of the optical axis, and front and back surfaces of the washers 6 are adhered and fixed to each other using the adhesive.

In such an image enlarging lens, however, if a position of the second lens 2 having a function as an adjusting lens is deviated even slightly, an image which is most suitable for a screen size to be projected (e.g., focus and size with respect to the screen size) can not be formed. If the adhesive is used at many locations, the second lens 2 is moved toward the washer 6 due to change with time (e.g., change in temperature and the like) at the adhered location and the position of the second lens 2 with respect to the direction of the optical axis is deviated.

When the washer 6 is used for adjusting the second lens 2 in the direction of the optical axis, it is necessary to insert the washer 6, this increases the operation steps, and the productivity and operation efficiency of the image enlarging lens are deteriorated. The washer 6 is formed by stamping a plate, and the washer 6 must have an outward shape corresponding to an inner diameter size of the barrel and having a thickness corresponding to a distance required for adjusting and moving the lens. Therefore, especially when it is necessary to use the plurality of washers 6, there is a problem that the number of the washers 6 and the producing cost are increased.

### SUMMARY OF THE INVENTION

It is an object of the present invention to at least solve the problems in the conventional technology.

A lens barrel according to one aspect of the present invention includes a lens that has a plurality of sliding surfaces on an outer peripheral edge of the lens; and a lens frame that has a plurality of lens-receiving sections on an inner peripheral edge of the lens frame and accommodates the lens. The sliding surfaces have different heights in a direction perpendicular to an optical axis of incident light. Each of the lens-receiving sections comes in contact with one of the sliding surfaces.

A lens barrel according to another aspect of the present invention includes a lens that has a plurality of slanting surfaces on an outer peripheral edge of the lens; and a lens frame that has a plurality of engaging sections on an inner peripheral edge of the lens frame and accommodates the lens. The heights of the slanting surfaces gradually change in a direction perpendicular to an optical axis of incident light. Each of the engaging sections engages with one of the sliding surfaces.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1A and FIG. 1B are sectional views illustrating one example of a configuration of a lens barrel according to a first embodiment;

FIG. 2 is a sectional view illustrating a partial configuration of the lens barrel of the first embodiment;

FIG. 3A to FIG. 3C illustrate a shape of a second lens used for the lens barrel of the first embodiment;

FIG. 4A and FIG. 4B illustrate a partial configuration of a first lens frame of the lens barrel of the first embodiment;

FIG. 5A to FIG. 5C illustrate a shape of a second lens used for a lens barrel of a second embodiment;

FIG. 6A and FIG. 6B illustrate a partial configuration of a first lens frame of the lens barrel of the second embodiment;.

FIG. 7A and FIG. 7B illustrate a shape of a second lens used for a lens barrel of a third embodiment;

FIG. 8A and FIG. 8B illustrate a partial configuration of a first lens frame of the lens barrel of the third embodiment;

FIG. 9A and FIG. 9B illustrate a shape of a second lens used for a lens barrel of a fourth embodiment;

FIG. 10A and FIG. 10B illustrate a partial configuration of a first lens frame of the lens barrel of the fourth embodiment;

FIG. 11 illustrates a partial configuration of a lens barrel of a fifth embodiment;

FIG. 12A to FIG. 12C illustrate a shape of a second lens used for a lens barrel of the fifth embodiment;

FIG. 13A and FIG. 13B illustrate a partial configuration of a first lens frame of the lens barrel of the fifth embodiment; and

FIG. 14 is a sectional view illustrating a partial configuration of a conventional image enlarging lens barrel.

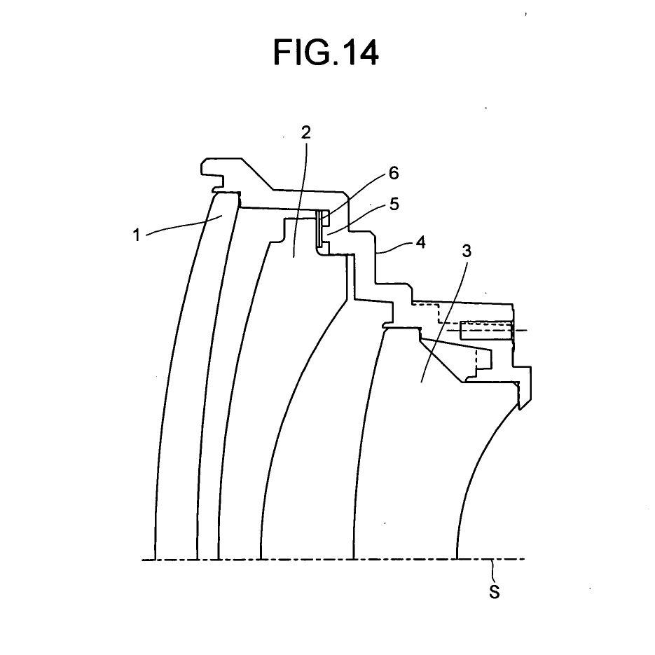

### DETAILED DESCRIPTION

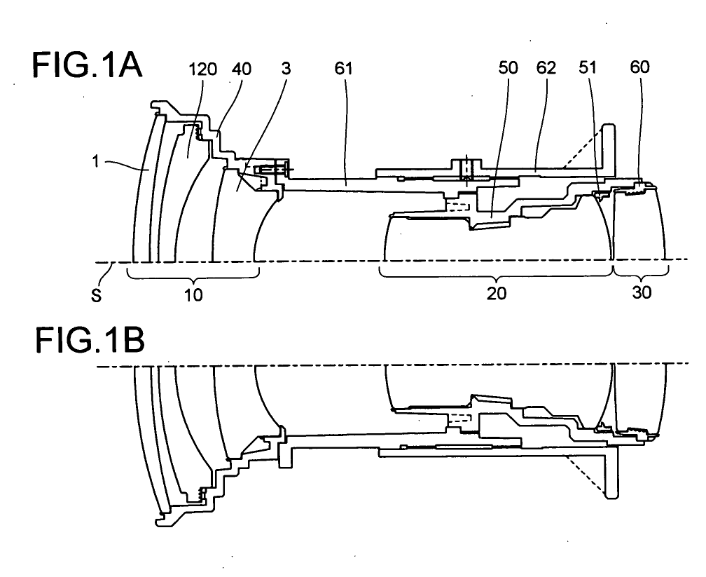

Exemplary embodiments of a lens barrel of the invention will be explained in detail with reference to the accompanying drawings below. An optical axis S is shown at necessary locations in the drawings. FIG. 1A and FIG. 1B are sectional views illustrating one example of a configuration of the lens barrel according to a first embodiment.

In the lens barrel of the embodiment, a first lens group 10, a second lens group 20 and a third lens group 30 are disposed in this order from the side closer to an image (not shown). The first lens group 10, the second lens group 20 and the third lens group 30 are held by a first lens frame 40, a second lens frame 50 and a third lens frame 60, respectively. The second lens frame 50 holds the second lens group 20 through a lens-holding member 51. The third lens frame 60 is inserted into the second lens frame 50. The second lens frame 50 is inserted in to a connection cylinder 61, and is connected to the first lens frame 40 through the connection cylinder 61.

The second lens frame 50 and the connection cylinder 61 are accommodated in a lens-holding frame 62. The first lens group 10 includes a first lens 1, a second lens 120 and a third lens 3 which are disposed in this order from the side closer to an image (not shown).

Each the lens constituting the lens barrel of this embodiment is made of synthetic resin. Therefore, the lens including its later-described sliding surface can easily and inexpensively be formed.

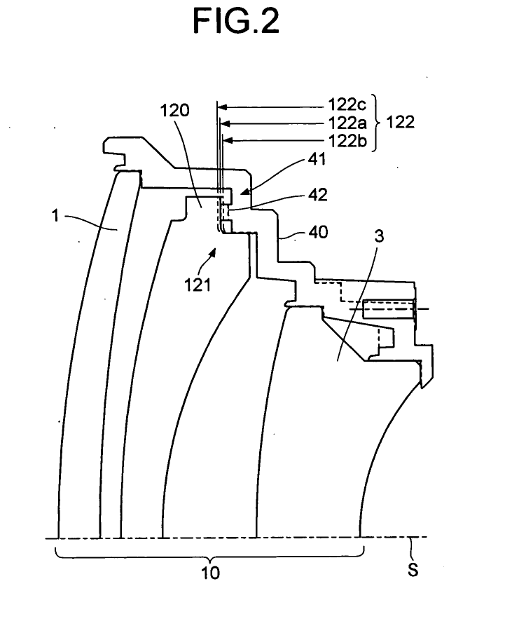

FIG. 2 is a sectional view illustrating a partial configuration of the lens barrel of this embodiment. FIG. 2 shows a state in which the first lens group 10 comprising the first lens 1, the second lens 120 and the third lens 3 arranged in this order from the side closer to the image (not shown) is held by the first lens frame 40. The first lens frame 40 is formed with a holding section 41 which holds the second lens 120. The holding section 41 is formed with a lens-receiving section 42 for fixing the second lens 120.

In the first embodiment, in order to fix the second lens 120 to the lens-receiving section 42, a periphery of a right side surface (side surface closer to a film) of the second lens 120 is formed with a step 121 along a thickness direction of the lens. The step 121 is provided with a sliding surface 122 which comes in contact with a lens-receiving section 42. The sliding surface 122 is formed with a reference surface 122a and adjusting surfaces 122b and 122c. Each of the reference surface 122a and the adjusting surfaces 122b and 122c is perpendicular to the optical axis.

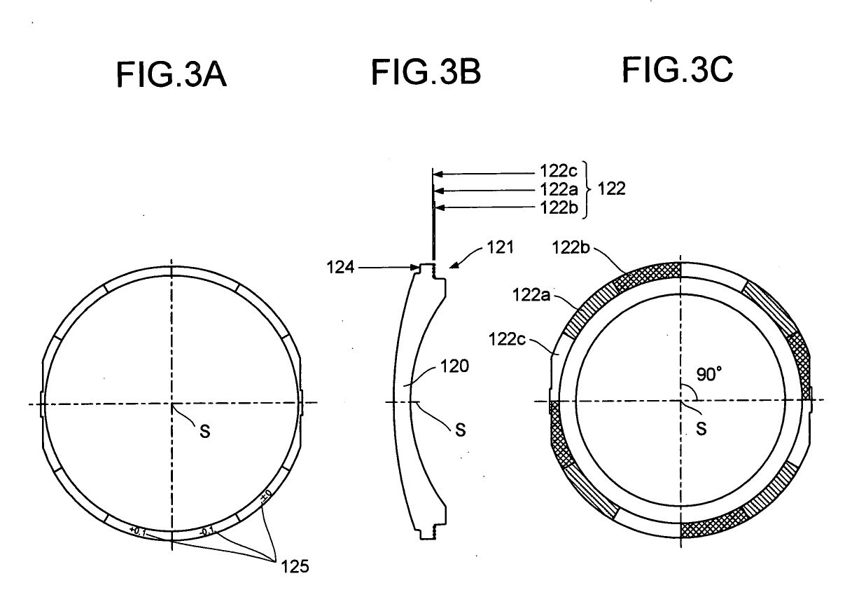

FIG. 3A to FIG. 3C illustrate a shape of the second lens 120. FIG. 3A is a plan view of the second lens 120, FIG. 3B is a left side view of FIG. 3A, and FIG. 3C is a right side view of FIG. 3A. The right side surface (side surface closer to a film) of the second lens 120 is formed with a region which equally divided is into four such that a central angle becomes 90°. The sliding surface 122 of the step 121 in each region is formed with the reference surface 122a, the adjusting surface 122b which is formed into a convex shape by the reference surface 122a and the adjusting surface 122c which is formed into a concave shape by the reference surface 122a.

The adjusting surface 122b is higher than the reference surface 122a by about 1/100 to 2/100 millimeter, and the adjusting surface 122c is lower than the reference surface 122a by about 1/100 to 2/100 millimeter. Positions of the reference surfaces 122a and the adjusting surfaces 122b and 122c formed in the divided regions are the same.

A left side surface of the second lens 120 is also formed with a step 124. Marks 125 as indices showing, with numerical values, heights of the reference surface 122a and the adjusting surfaces 122b and 122c formed on the right side surface are indicated at positions corresponding to these surfaces. The numerical values includes “±0” corresponding to the reference surface 122a, “+0.1” corresponding to the adjusting surface 122b, and “−0.1” corresponding to the adjusting surface 122c.

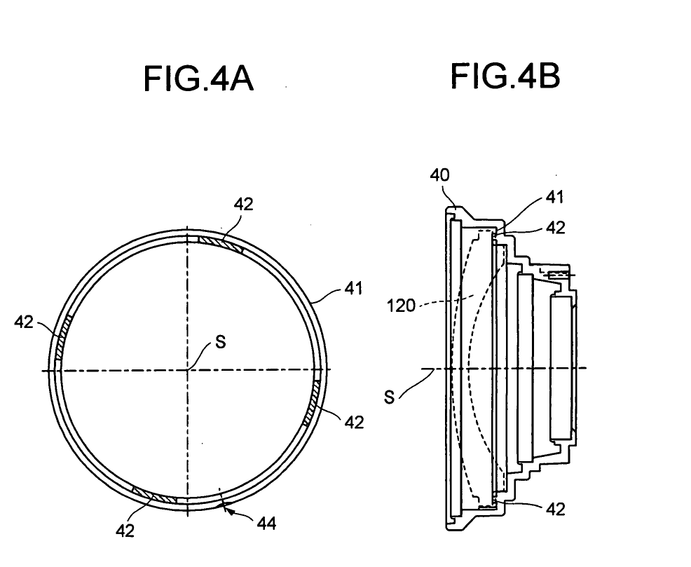

FIG. 4A and FIG. 4B illustrate a partial configuration of the first lens frame 40 of the lens barrel according to the first embodiment. FIG. 4A is a plane view illustrating the partial configuration of the first lens frame 40, and FIG. 4B is a left side view of FIG. 4A. The first lens frame 40 is formed with the holding section 41 which holds the second lens 120. The holding section 41 is formed at its four locations with lens-receiving sections 42 for fixing the second lens 120. The lens-receiving section 42 has a surface perpendicular to the optical axis. Therefore, even if the second lens 120 is rotated around the optical axis, a relation between the lens and the optical axis is not changed.

The first lens frame 40 is formed with a confirmation index 44 so as to grasp or find out which one of the surfaces (one of the reference surface 122a, the adjusting surface 122b and the adjusting surface 122c) of the sliding surface 122 formed on the right side surface of the second lens 120 is in contact with the lens-receiving section 42 of the first lens frame 40. Therefore, it is possible to grasp which one of the surfaces of the sliding surface 122 formed on the second lens 120 is in contact with the lens-receiving section 42 of the first lens frame 40 by referring to the mark 125 of the second lens 120 located at a position of the confirmation index 44.

For example, the numerical value “±0” of the mark 125 of the second lens 120 is located at the position of the confirmation index 44 as viewed from front side of the optical axis, and it is possible to easily judge that the reference surface 122a of the sliding surface 122 is in contact with the lens-receiving section 42. In addition, when the second lens 120 is adjusted with respect to the optical axis, the. adjusting direction can easily be judged.

In this lens barrel, the second lens 120 is rotated around the optical axis in a state in which the sliding surface 122 of the second lens 120 is in contact with the lens-receiving section 42 of the first lens frame 40, thereby moving the second lens 120 in the direction of the optical axis to position the second lens 120. Then, the lens-receiving section 42 and the sliding surface 122 are fixed to each other. The adhesive or the like is used for fixing them. Since the adhesive is used on one location between the lens-receiving section 42 and the sliding surface 122, deviation therebetween in the optical axis caused by the change with time can be minimized.

According to the lens barrel of the first embodiment, the second lens 120 is provided with the sliding surface 122 having the different height from that perpendicular to the direction of the optical axis, and the sliding surface 122 is brought in contact with the lens-receiving section 42. Therefore, the second lens 120 can be moved and adjusted in the direction of the optical axis only by rotating the second lens 120, and the operation step required for this adjustment can be simplified. Since the second lens 120 can be varied in a quantitative manner in the direction of the optical axis, it is possible to easily adjust (finely adjust) the focus of the image enlarging lens.

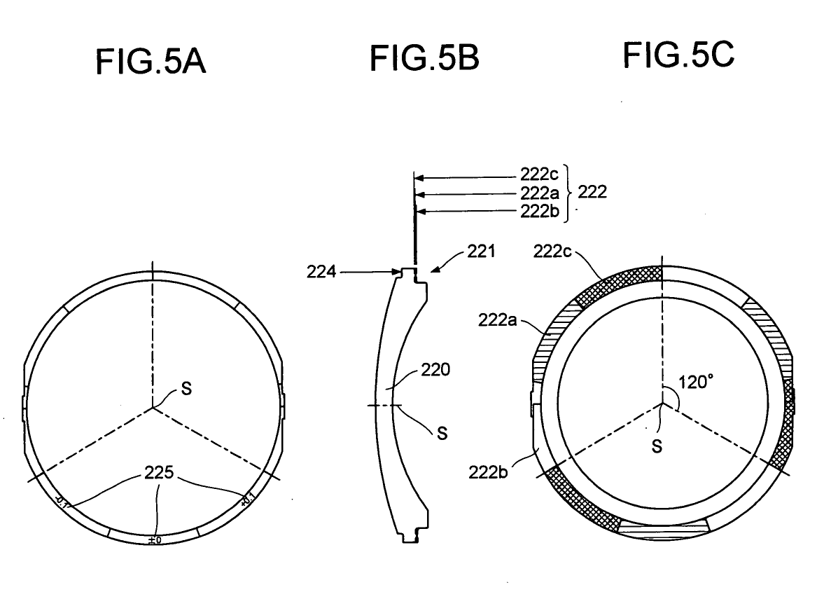

A second embodiment is a modification of the lens barrel shown in the first embodiment. FIG. 5A to FIG. 5C illustrate a shape of the second lens used for the lens barrel in the second embodiment. FIG. 5A is a plan view of a second lens 220, Fig: 5B is a left side view of FIG. 5A, and FIG. 5C is a right side view of FIG. 5A. As shown in FIG. 5A to FIG. 5C, in the second embodiment, a right side surface (side surface closer to a film) of the second lens 220 is formed with a region which is equally divided into three such that the central angle becomes 120°. Like the first embodiment, each the divided region is formed with a step 221. The step 221 is formed with a sliding surface 222. The sliding surface 222 comprises a reference surface 222a, an adjusting surface 222b which is formed into a convex shape by the reference surface 222a and an adjusting surface 222c which is formed into a concave shape by the reference surface 222a.

The adjusting surface 222b is higher than the reference surface 222a by about 1/100 to 2/100 millimeter, and the adjusting surface 222c is lower than the reference surface 222a by about 1/100 to 2/100 millimeter. Positions of the reference surfaces 222a and the adjusting surfaces 222b and 222c formed in the divided regions are the same.

A left side surface of the second lens 220 is also formed with a step 224. Marks 225 showing heights of the reference surface 222a and the adjusting surfaces 222b and 222c formed on the right side surface are indicated at positions corresponding to these surfaces. The numerical values includes “(0” corresponding to the reference surface 222a, “+0.1” corresponding to the adjusting surface 222b, and “−0.1” corresponding to the adjusting surface 222c.

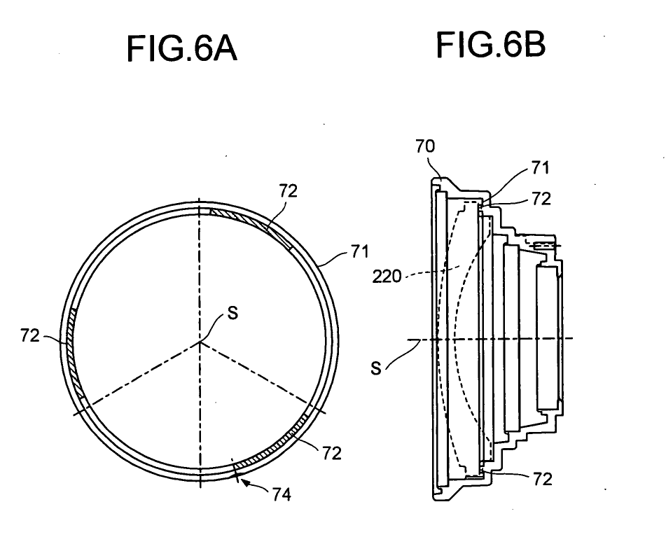

FIG. 6A and FIG. 6B illustrate a partial configuration of the first lens frame 70 of the lens barrel according to the second embodiment. FIG. 6A is a plane view illustrating the partial configuration of the first lens frame 70, and FIG. 6B is a left side view of FIG. 6A. The first lens frame 70 is formed with the holding section 71 which holds the second lens 220. The holding section 71 is formed at its three locations with lens-receiving sections 72 for fixing the second lens 220. The lens-receiving section 72 has a surface perpendicular to the optical axis.

The number of each of the sliding surfaces 222 and the lens-receiving sections 72 is three which is minimum number which holds the second lens 220. Therefore, even if the second lens 220 is rotated around the optical axis, the relation between the lens and the optical axis is not changed, and it is possible to stably adjust and hold the fixed state of the lens.

The first lens frame 70 is formed with a confirmation index 74 so as to grasp or find out which one of the surfaces (one of the reference surface 222a, the adjusting surface 222b and the adjusting surface 222c) of the sliding surface 222 formed on the right side surface of the second lens 220 is in contact with the lens-receiving section 72 of the first lens frame 70. Therefore, it is possible to grasp which one of the surfaces of the sliding surface 222 formed on the second lens 120 is in contact with the lens-receiving section 72 of the first lens frame 70 by referring to the mark 225 of the second lens 220 located at a position of the confirmation index 74.

For example, the numerical value “±0” of the mark 225 of the second lens 220 is located at the position of the confirmation index 74 as viewed from front side of the optical axis, and it is possible to easily judge that the reference surface 222a of the sliding surface 222 is in contact with the lens-receiving section 72. In addition, when the second lens 220 is adjusted with respect to the optical axis, the adjusting direction can easily be judged.

According to the lens barrel of the second embodiment, the second lens 220 is provided with the sliding surface 222 having the different height from that perpendicular to the direction of the optical axis, and the sliding surface 222 is brought in contact with the lens-receiving section 72. Therefore, the second lens 220 can be moved and adjusted in the direction of the optical axis only by rotating the second lens 220, and the operation step required for this adjustment can be simplified. Since the second lens 220 can be varied in a quantitative manner in the direction of the optical axis, it is possible to easily adjust (finely adjust) the focus of the image enlarging lens. In addition, the number of each of the lens-receiving sections 72 and the sliding surfaces 222 is three which is minimum number for holding them on the circumference. Therefore, it is easy to form these members and it is possible to adjust and hold the second lens 220 in a most stable state.

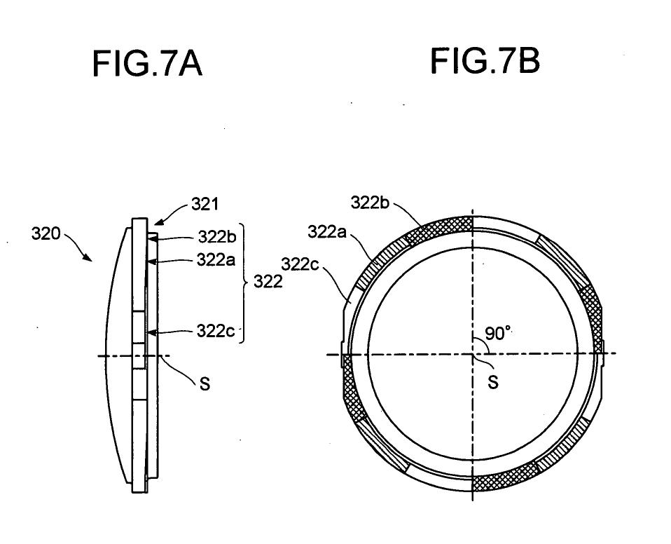

A third embodiment of this invention will be explained next. The third embodiment is also a modification of the lens barrel shown in the first embodiment. FIG. 7A and FIG. 7B illustrate a shape of the second lens 320 used for the lens barrel in the third embodiment. FIG. 7A is a plan view of the second lens 320, and FIG. 7B is a right side view of FIG. 7A. A right side surface (side surface closer to a film) of the second lens 320 is formed with a region which is equally divided into four such that the central angle becomes 90(. Each region has a step 321 including a sliding surface 322. The sliding surface 322 is formed with a reference surface 322a, an adjusting surface 322b which is formed into a convex shape by the reference surface 322a and an adjusting surface 322c which is formed into a concave shape by the reference surface 322a.

The reference surface 322a is formed into a tapered shape having a smooth slanting surface which continuously extends from the adjusting surface 322b to the adjusting surface 322c. A central portion of this reference surface 322a is a reference position. A position of the adjusting surface 322b is higher than the reference position of the reference surface 322a by about 1/100 to 2/100 millimeter, and a position of the adjusting surface 322c is lower than the reference position of the reference surface 322a by about 1/100 to 2/100 millimeter. Positions of the reference surfaces 322a and the adjusting surfaces 322b and 322c formed in the divided regions are the same.

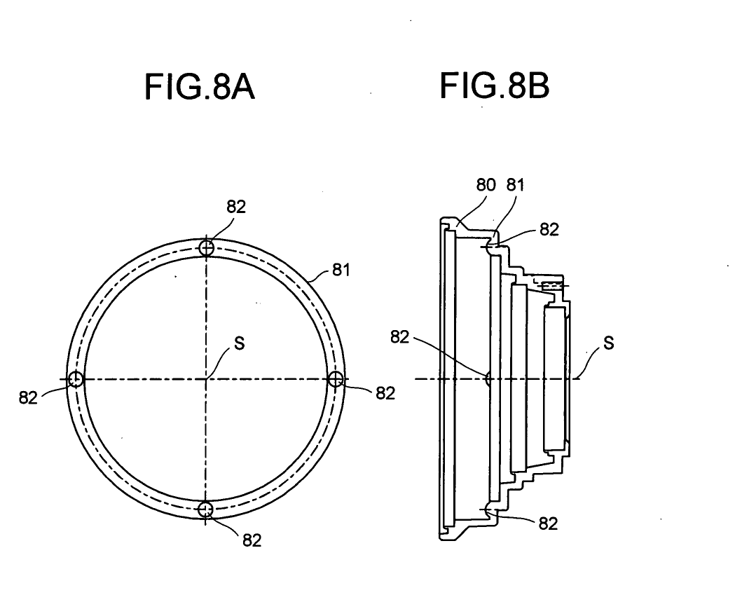

FIG. 8A and FIG. 8B illustrate a partial configuration of the first lens frame 80 of the lens barrel according to the third embodiment. FIG. 8A is a plane view illustrating the partial configuration of the first lens frame 80 and FIG. 8B is a left side view of FIG. 8A. The first lens frame 80 is formed with the holding section 81 which holds the second lens 320. The holding section 81 is formed at its four locations with lens-receiving sections 82 for fixing the second lens 320. The lens-receiving section 82 is of semi-spherical shape. The lens-receiving section 82 receives the sliding surface 322 in a point-contact manner, and the lens-receiving section 82 may be of conical shape for example.

According to the lens barrel of the third embodiment, the second lens 320 is provided with the sliding surface 322 having the different height from that perpendicular to the direction of the optical axis, and the sliding surface 322 is brought in contact with the lens-receiving section 82. Therefore, the second lens 320 can be moved and adjusted in the direction of the optical axis only by rotating the second lens 320, and the operation step required for this adjustment can be simplified. Since the reference surface 322a of the sliding surface 322 is formed into the tapered shape having the smooth slanting surface, it is possible to continuously and finely change the second lens 320 in the vicinity of the reference position in the direction of the optical axis. Thus, it is possible to more easily adjust (finely adjust) the focus of the image enlarging lens.

Although it is not specifically described in the third embodiment, if the confirmation indices and the marks are provided like the lens barrel of the first embodiment, it is possible to grasp or find out which one of the surfaces of the sliding surface 322 formed on the second lens 320 is in contact with the lens-receiving section 82 of the first lens frame 80.

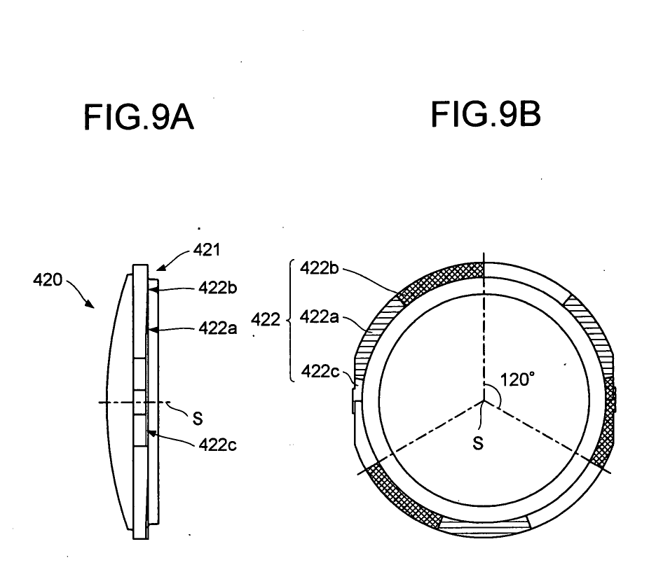

A fourth embodiment of this invention will be explained next. The fourth embodiment is a modification of the lens barrel shown in the third embodiment. FIG. 9A and FIG. 9B illustrate a shape of the second lens 420 used for the lens barrel in the third embodiment. FIG. 9A is a plan view of the second lens 420, and FIG. 9B is a right side view of FIG. 9A.

A right side surface (side surface closer to a film) of the second lens 420 is formed with a region which is equally divided into three such that the central angle becomes 1200. Each region has a step 421 including a sliding surface 422. The sliding surface 422 is formed with a reference surface 422a, an adjusting surface 422b which is formed into a convex shape by the reference surface 422a and an adjusting surface 422c which is formed into a concave shape by the reference surface 422a. The reference surface 422a is formed into a tapered shape having a smooth slanting surface which continuously extends from the adjusting surface 422b to the adjusting surface 422c. A central portion of this reference surface 422a is a reference position.

The highest position of the adjusting surface 422b is higher than a reference position. of the reference surface 422a by about 1/100 to 2/100 millimeter, and the lowest position of the adjusting surface 422c is lower than the reference position of the reference surface 422a by about 1/100 to 2/100 millimeter. Positions of the reference surfaces 422a and the adjusting surfaces 422b and 422c formed in the divided regions are the same.

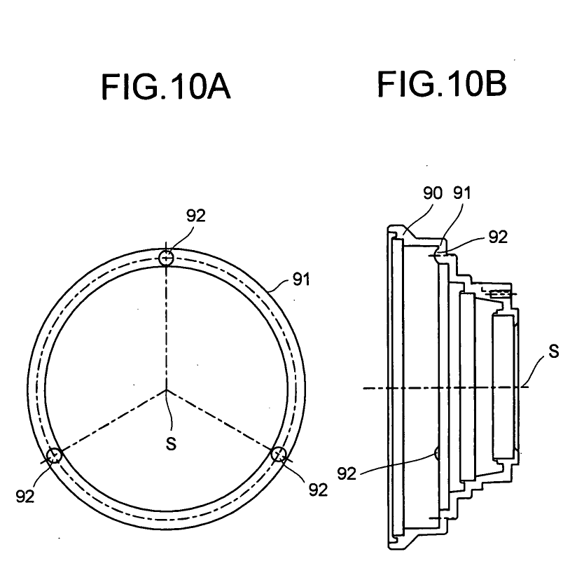

FIG. 10A and FIG. 10B illustrate a partial configuration of the first lens frame 90 of the lens barrel according to the fourth embodiment. FIG. 10A is a plane view illustrating the partial configuration of the first lens frame 90, and FIG. 8B is a left side view of FIG. 8A.

The first lens frame 90 is formed with the holding section 91 which holds the second lens 420. The holding section 91 is formed at its four locations with lens-receiving sections 92 for fixing the second lens 420. The lens-receiving section 92 is of semi-spherical shape. The lens-receiving section 92 receives the sliding surface 422 in a point-contact manner, and the lens-receiving section 92 may be of conical shape for example.

According to the lens barrel of the fourth embodiment, the second lens 420 is provided with the sliding surface 422 having the different height from that perpendicular to the direction of the optical axis, and the sliding surface 422 is brought in contact with the lens-receiving section 92. Therefore, the second lens 420 can be moved and adjusted in the direction of the optical axis only by rotating the second lens 420, and the operation step required for this adjustment can be simplified. Since the second lens 420 can be varied in a quantitative manner in the direction of the optical axis, it is possible to easily adjust (finely adjust) the focus of the image enlarging lens. The number of each of the lens-receiving sections 92 and the sliding surfaces 422 is three which is minimum number for holding them on the circumference. Therefore, it is easy to form these members and it is possible to adjust and hold the second lens 420 in a most stable state. Since the reference surface 422a of the sliding surface 422 is formed into the tapered shape having the smooth slanting surface, it is possible to continuously and finely change the second lens 420 in the vicinity of the reference position in the direction of the optical axis. Thus, it is possible to more easily adjust (finely adjust) the focus of the image enlarging lens.

Although it is not specifically described in the fourth embodiment, if the confirmation indices and the marks are provided like the lens barrel of the first embodiment, it is possible to easily recognize as to which one of the surfaces of the sliding surface 422 formed on the second lens 420 is in contact with the lens-receiving section 92 of the first lens frame 90.

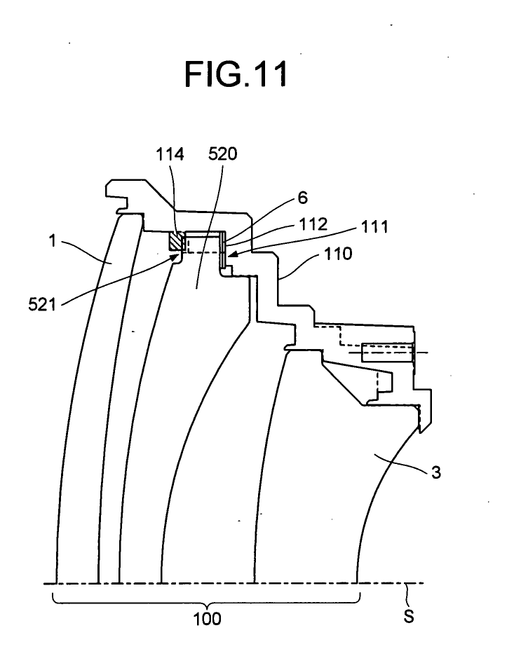

A fifth embodiment of this invention will be explained next. FIG. 11 is a sectional view illustrating a partial configuration of a lens barrel of the fifth embodiment. In FIG. 11, a first lens group 100 having a first lens 1, a second lens 520 and a third lens 3 arranged in this order from the side closer to the image (not shown) is held by the first lens frame 110.

The first lens frame 110 is formed with a holding section 111 which holds the second lens 520. The second lens 520 is fixed by fixing a second lens 520 formed on a periphery of a left side surface of the second lens 520 and a lens-fixing section 114 provided on the first lens frame 110 by means of adhesive. In order to adjust the focus of the image enlarging lens for forming an image which is most suitable for the screen size to be projected, a washer 6 is interposed between the second lens 520 and the lens-receiving section 112 formed on the holding section 111, and the position of the second lens 520 in a direction along the optical axis is adjusted. Details will be explained below.

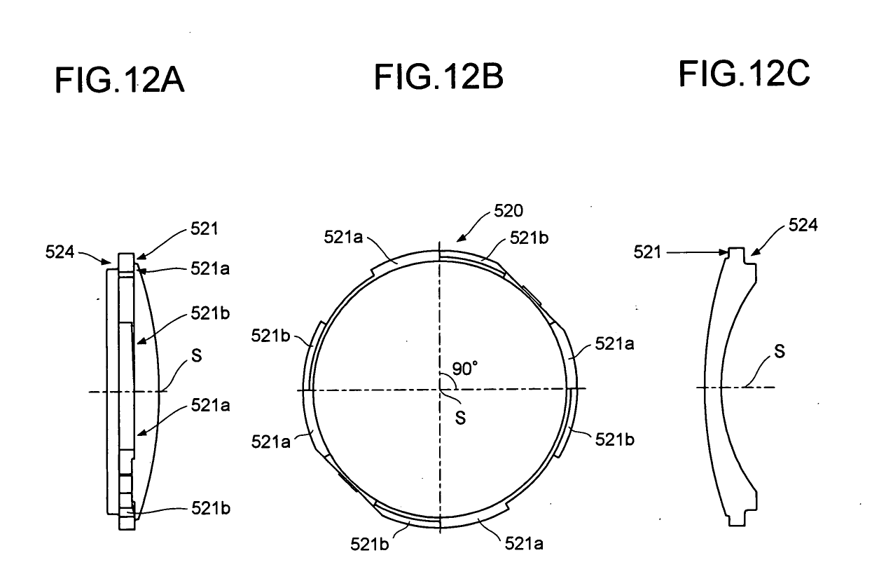

FIG. 12A to FIG. 12C illustrate a shape of the second lens 520. FIG. 12A is a front view of the second lens 520, FIG. 12B is a left side view of FIG. 12A and FIG. 12C is a right side view of FIG. 12A. A periphery of a front surface of the second lens 520 is formed with a step 521. The front surface of the second lens 520 is formed with a region which is equally divided into four such that the central angle becomes 90°. The step 521 in each region is provided with a flat surface section 521a and a slanting surface section 521b. The slanting surface section 521b is a smooth slanting surface, and a difference between the highest portion and the lowest portion of the slanting surface is about 1/100 to 4/100 millimeter. Positions of the flat surface section 521a and the slanting surface section 521b formed in the divided regions are the same.

A right side (side closer to a film) of the second lens 520 is also formed with a step 524. This step 524 is a sliding surface with respect to the lens-receiving section 112.

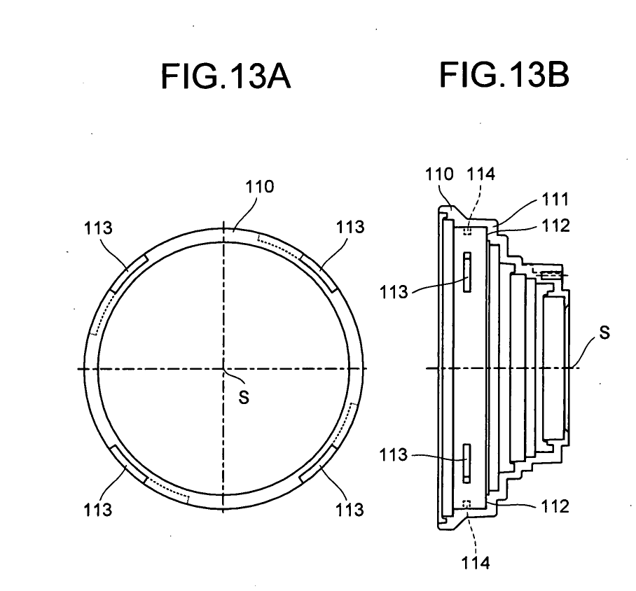

FIG. 13A and FIG. 13B illustrate a partial configuration of a first lens frame 110 of the lens barrel of the fifth embodiment. FIG. 13A is a plan view illustrating the partial configuration of the first lens frame 110, and FIG. 13B is a left side view of FIG. 13A. The first lens frame 110 is formed with a holding section 111 which holds the second lens 520. The holding section 111 is formed with a lens-receiving section 112 which fixes the second lens 520. The lens-receiving section 112 is a surface perpendicular to the optical axis. The first lens frame 110 is formed at its four locations with bayonet convex sections (engaging sections) 113. When the second lens 520 is fixed to the first lens frame 110, the slanting surface section 521b of the second lens 520 is engaged with the bayonet convex sections 113.

By rotating the second lens 520 around the optical axis, the second lens 520 moves in the direction of the optical axis, and it is possible to bring the entire image enlarging lens into focus. The first lens frame 110 is formed with the lens-fixing section 114 for fixing the second lens 520. The slanting surface section 521b is a constituent section whose height is continuously varied in the direction of the optical axis like the sliding surface, especially the tapered reference surfaces 322a and 422a explained in the previous embodiments.

In the lens barrel of the fifth embodiment, the slanting surface section 521 b of the second lens 520 is engaged with the bayonet convex sections 113, the second lens 520 is rotated around the optical axis to move the second lens 520 in the direction of the optical axis, and the second lens 520 is positioned so that the image enlarging lens can form a desired image.

If a gap is adversely generated between the step 524 of the second lens 520 and the lens-receiving section 112 of the first lens frame 110, the washer 6 is inserted into the gap and then, the slanting surface section 521b of the second lens 520 is engaged with the bayonet convex sections 113 of the first lens frame 110. Lastly, the flat surface section 521a of the second lens 520 and the lens-fixing section 114 of the first lens frame 110 are adhered and fixed to each other using the adhesive. The adhering position is not on the side of the washer 6. If the side of the washer 6 is adhered, it is necessary to attach both the front and back surfaces of the washer 6. Only one location of the flat surface section 521a of the second lens 520 and only one location of the lens-fixing section 114 of the first lens frame 110 are adhered to each other. Since the adhesive is used in the portions which do not deviate the position of the fixed second lens 520 in this manner, the deviation in position which may be caused by the thickness of the adhesive and shrinkage of the adhesive can be avoided.

According to the lens barrel of the fifth embodiment, since the slanting surface section 521b having the smooth slanting surface is engaged with the bayonet convex sections 113, it is possible to continuously change the position of the second lens 520 in the direction of the optical axis by rotating the second lens 520 around the optical axis, and to adjust (finely adjust) the focus of the image enlarging lens.

The embodiments of the present invention have been explained above with reference to the drawings. However, the invention is not limited to the embodiments, and it is of course possible to modify and improve the invention based on the description in the appended claims. For example, although the holding structure of the second lens which constitutes the first lens group is indicated in each of the embodiments, other lens can also be provided with the same holding structure as that of the second lens.

According to the present invention as described above, the lens can be held by moving and adjusting the lens in the direction of the optical axis with respect to the lens frame. Since the lens which comes in contact with the lens-receiving section has the sliding surface whose height is different in the direction of the optical axis, the lens can be moved in the direction of the optical axis only by rotating the lens with respect to the lens frame, and there is effect that the adjusting operation of the focus by moving the lens can easily and efficiently be carried out.

The present document incorporates by reference the entire contents of Japanese priority document, 2003-001606 filed in Japan on Jan. 7, 2003.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A lens barrel comprising,
a lens that has a plurality of sliding surfaces on an outer peripheral edge of the lens, the sliding surfaces having different heights in a direction perpendicular to an optical axis of incident light; and
a lens frame that has a plurality of lens-receiving sections on an inner peripheral edge of the lens frame, and accommodates the lens, each of the lens-receiving sections coming in contact with one of the sliding surfaces.

2. The lens barrel according to claim 1, wherein a portion of the lens-receiving section is a flat surface perpendicular to the optical axis, and the portion comes in contact with of the sliding surfaces.

3. The lens barrel according to claim 1, wherein a portion of the lens-receiving section comes in contact with one of the sliding surface at a point.

4. The lens barrel according to claim 3, wherein a portion of at least one of the sliding surfaces has a substantially tapered shape that has a predetermined inclination with respect to the direction of the optical axis.

5. The lens barrel according to claim 1, wherein the lens has four sliding surfaces that are respectively formed on four regions into which a surface of the lens is equally divided.

6. The lens barrel according to claim 5, wherein each of the sliding surfaces is formed in same position with respect to a region on which the each of the sliding surfaces is formed.

7. The lens barrel according to claim 1, wherein the lens has three sliding surfaces that are respectively formed on four regions into which a surface of the lens is equally divided.

8. The lens barrel according to claim 7, wherein each of the sliding surfaces is formed in same position with respect to a region on which the each of the sliding surfaces is formed.

9. The lens barrel according to claim 1, wherein each of the outer peripheral edge and the inner peripheral edge has a plurality of indices, and each of the indices indicates which one of the sliding surfaces comes in contact with one of the lens-receiving sections.

10. A lens barrel comprising:
a lens that has a plurality of slanting surfaces on an outer peripheral edge of the lens, heights of the slanting surfaces gradually changing in a direction perpendicular to an optical axis of incident light; and
a lens frame that has a plurality of engaging sections on an inner peripheral edge of the lens frame, and accommodates the lens, each of the engaging sections engaging with one of the sliding surfaces.

11. The lens barrel according to claim 10, further comprising:
a lens-receiving section that is provided on the lens frame; and
a washer that is interposed between the lens-receiving section and a surface of the lens which comes in contact with the lens-receiving section, and has a predetermined thickness that allows adjustment of a position of the lens in a direction of the optical axis.
